(19) United States
(12) Patent Application Publication
(10) Pub. No.: US 2012/0305518 A1
(43) Pub. Date: Dec. 6, 2012

(54) HOT FILL CONTAINERS AND METHODS

(75) Inventors: Joseph M. Ladina, Marietta, GA (US); Robert P. Grant, Alpharetta, GA (US); Sterling Steward, Douglasville, GA (US); Louis Mattos, JR., Douglasville, GA (US)

(73) Assignee: THE COCA-COLA COMPANY, Atlanta, GA (US)

(21) Appl. No.: 13/150,282

(22) Filed: Jun. 1, 2011

(51) Int. Cl. B65D 51/16; B67B 3/00

(52) U.S. Cl. 215/307; 53/471; 53/281

(57) ABSTRACT

The present application and the resultant patent provide a container for a beverage filled in a hot fill process. The container may include a bottle and a closure. The closure may include a vent therein having a top side with an amount of excess material and a bottom side with a porous component.

### TECHNICAL FIELD

The present application and the resultant patent relate generally to beverage containers and more particularly relate to beverage containers having a bottle and a vented closure as well as methods of filling the beverage containers via hot fill processes.

### BACKGROUND OF THE INVENTION

Beverages such as sport drinks, juices, teas, and the like are often bottled via hot fill processes so as to prevent microbial growth. The hot fill processes generally involve pasteurizing the beverage at about 95 degrees Celsius for about 20 seconds, cooling the beverage to about 85 degrees Celsius, and then filling bottles with the beverage. The 85 degrees temperature generally is sufficient to sterilize the bottles. A closure is then applied to the bottle to create a sealed container. The container may be inverted for about 15 to about 20 seconds to sterilize the closure. The container is then passed through a cooling tunnel after filling and capping to be cooled via a water spray or other methods for about 20 minutes. The final temperature of the beverage after the cooling process is generally less than 40 degrees Celsius. Other types of hot fill processes may be known using different times, temperatures, and equipment. Different types of beverages also may necessitate different techniques.

During the cooling process, the beverage contracts such that a vacuum forms within the enclosed container. To help offset the impact of such a vacuum, bottles used in the hot fill processes generally have special vacuum panels formed therein. These vacuum panels and the areas therebetween generally promote a controlled deformation or deflection to accommodate the forces created by the vacuum while maintaining the overall integrity of the bottle. These hot filled bottles generally thus demand relatively complex shapes and use significantly more polymer material as compared to cold filled bottles. As a result, hot fill bottles are more expensive to produce in terms of both tooling and material and also offer less design freedom.

There is thus a desire for improved hot fill containers and methods of filling the same. Such improved containers may include bottles and closures that may accommodate the contraction of a beverage therein while maintaining the overall integrity of the bottle without the complexity, the weight, and the costs typically associated with hot fill bottles.

### SUMMARY OF THE INVENTION

The present application and the resultant patent thus provide a container for a beverage filled in a hot fill process. The container may include a bottle and a closure. The closure may include a vent therein having a top side with an amount of excess material and a bottom side with a porous component.

The present application and the resultant patent further provide a method of bottling a hot liquid. The method may include the steps of filling a bottle with the hot liquid, capping the bottle with a vented closure, cooling the hot liquid within the bottle, pulling air into the bottle through the vented closure, and sealing the vented closure. The sealing step may include laser sealing.

The present application and the resultant patent further provide a hot fill bottling line. The hot fill bottling line may include a filling station for filling a bottle with a hot liquid, a capping station for capping the bottle with a vented closure, a cooling station for cooling the hot liquid and pulling air through the vented closure, and a sealing station for sealing the vented closure. The sealing station may include one or more lasers.

These and other features and improvements of the present application and the resultant patent will become apparent to one of ordinary skill in the art upon review of the following detailed description when taken in conjunction with the several drawings and the appended claims.

### BRIEF DESCRIPTION OF DRAWINGS

FIG. 1 is a plan view of a container as may be described herein with a portion of a closure shown in a side cross-sectional view.

FIG. 2 is a side cross-sectional view of the closure of FIG. 1 showing a vent therein.

FIG. 3 is a top perspective view of the closure of FIG. 1.

FIG. 4 is a side plan view of the closure of FIG. 1.

FIG. 5 is a bottom perspective view of the closure of FIG. 1.

FIG. 6 is a schematic view of a hot fill bottling line as may be described herein.

FIG. 7 is a plan view of an alternative embodiment of a container as may be described herein with a portion of the closure shown in a side cross-sectional view.

FIG. 8 is a side cross-sectional view of the closure of FIG. 7 showing a vent therein.

FIG. 9 is a top perspective view of the closure of FIG. 7.

FIG. 10 is a bottom perspective view of the closure of FIG. 7.

FIG. 11 is a top perspective view of an alternative embodiment of a closure as may be described herein.

FIG. 12 is a side perspective view of the closure of FIG. 11.

### DETAILED DESCRIPTION

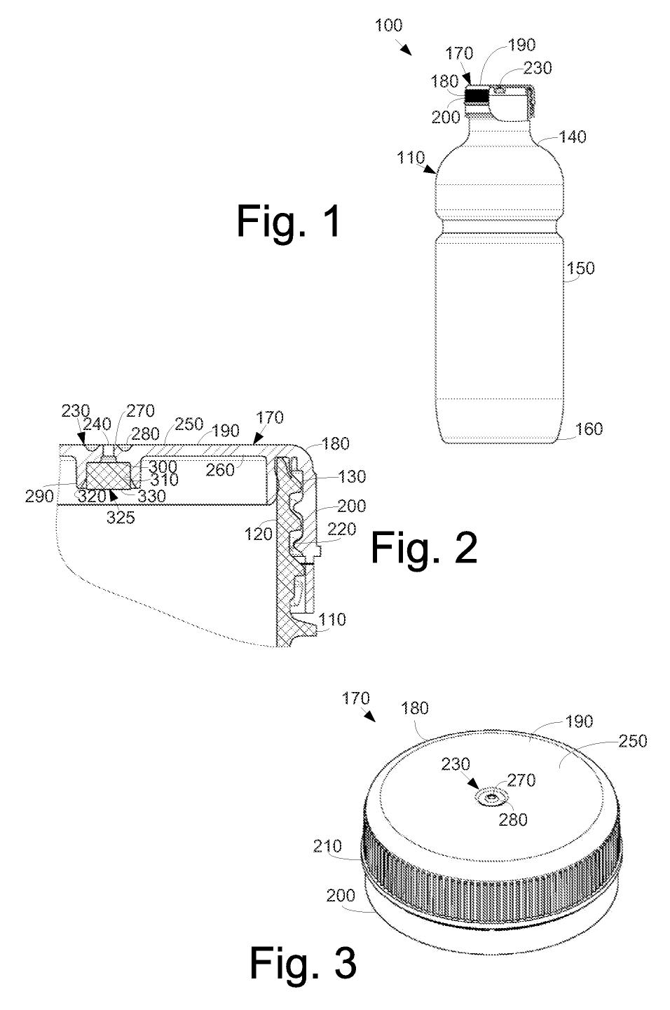

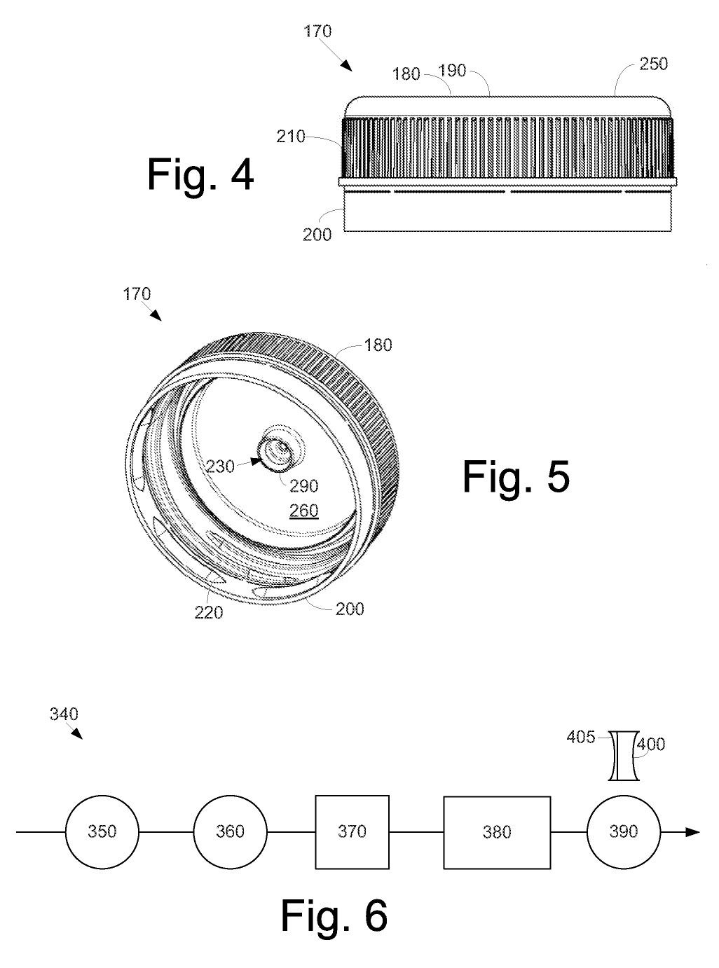

Referring now to the drawings in which like numerals refer to like elements throughout the several views, FIG. 1-5 show a container 100 as may be described herein. The container 100 may include a bottle 110. The bottle 110 may have any desired size or shape. The bottle 110 may be made from an injection molded preform. The preform may be made from various types of polymer resins. These polymer resins may include polyesters, polyolefins, polypropylene, polycarbonates, nitrates, and copolymers thereof. Biaxially oriented polyethylene terephthalate (“PET”) may be commonly used. Other materials such as polylactide acid (“PLA”) and the like also may be used herein. The polymers may be clear or opaque. Generally described, the bottle 110 may include an open mouth 120, a threaded neck 130, a shoulder 140, a main body portion 150, and a bottom portion 160 in any desired configuration. The bottle 110 preferably does not require vacuum panels or at least does not require as many vacuum panels or vacuum panels of typical complexity.

The container 110 also may include a closure 170. The closure may be made from a polymer such as polypropylene, polyethylene, and other types of materials. The closure 170 may include a shell 180 with a top flat surface 190 and a skirt 200 descending therefrom. The skirt 200 may include a series of ridges 210 on the outside thereof to assist in gripping and a number of threads 220 on the inside so as to mate with the threaded neck 130 of the open mouth 120 of the bottle 110. Other configurations also may be used herein. The closure 170 and the components therein may be manufactured by injection or compression molding techniques and the like.

The closure 170 may have a vent 230 formed or placed therein. The vent 230 may be positioned about the middle of the flat surface 190 with a vent hole 240 extending therethrough. The vent hole 240 thus may extend from a top side 250 of the flat surface 190 to a bottom side 260. The vent hole 240 may extend through a recessed dimple 270 on the top side 250 of the flat surface 190. By the term “dimple”, we mean any type or amount of excess material about or within the vent hole 240. The recessed dimple 270 may be surrounded by an indented ring 280. The vent hole 240 may be formed by piercing, molding, or via other techniques. The vent hole 240 may have a diameter of about one millimeter. Other sizes and shapes may be used herein.

The vent 230 may include a retaining ring 290 on the bottom side 260. The retaining ring 290 may include an upper surface 300 and a circular side surface 310. The retaining ring 290 may have a cutout portion 320 on one end thereof. A porous component 325 may be positioned within the retaining ring 290. For example, the porous component 325 may be a porous plug 330 in the form of a hydrophobic porous plastic disk. The porous plug 330 may be made from a thermoplastic material, including Ultra-High Molecular Weight Polyethylene (UHMWPE), High-Density Polyethylene (HDPE), Polypropylene (PP), PTFE, PVDF, EVA, Nylon-6, Polyethylene (PE), PE/PP Co-polymer, and combinations thereof. Other types of materials may be used herein. The porous plug 330 may have pore sizes therein of about 8 to 15 microns or so to allow air to vent while preventing the intrusion of cooling water and catching any contaminates that may be in the air stream via a tortuous path therethrough. The porous plug 330 may be laser welded into the retaining ring 290 along both the upper surface 300 and the side surface 310. The cutout 320 allows proper positioning of the porous plug 330 therein in an automated fashion. Other configurations and other types of components may be used herein.

FIG. 6 shows a hot fill bottling line 340 as may be described herein. Similar to that described above, the bottle 110 of the container 100 may be filled with a beverage in a filling station 350. The bottle 110 may be capped with the closure 170 in a capping station 360. The closure 170 may be preassembled with the porous plug 330 being laser welded within the retaining ring 290 and the vent hole 240 being pierced through the recessed dimple 270. The container 110 may be inverted in an inverting station 370. The container 110 then may be cooled within a cooling tunnel 380 and the like.

As the beverage within the container 100 cools, the beverage will contract and begin to pull a vacuum therein. Purified air, however, may be pulled through the vent 230 in the closure 170 and into the bottle 110 to offset the vacuum and allow for pressure equalization. Once the headspace within the container 100 has cooled and reached an equilibrium pressure, the container 100 may be sent to a laser station 390. The laser station 390 may have one or more lasers 100 positioned therein. The laser 400 may focus on the recessed dimple 270 of the closure 170. Specifically, an amount of energy may be focused on the recessed dimple 270 so as to cause the polymer material within the recessed dimple 270 to collapse and seal the vent hole 240 therethrough in a hermetic fashion. The laser 400 may use about 10 to about 50 watts of sealing energy in about 0.3 to about 0.5 seconds. Other components and other configurations may be used herein. An inspection station also may be used herein. For example, a pyrometer 405 also may be used to ensure the integrity of the seals.

The vent 230 thus may be hermetically sealed so as to prevent intrusion of oxygen, toxic fumes, or anything else into the container 100 during storage and distribution. The vent 230 also prevents a pressure build-up in the container 100 before cooling. The use of dark colors in the closure 170 helps to absorb the laser energy therein. Additives may be used to assist in energy absorption with the use of materials having less dark colors. The container 110 en may be distributed to the consumer in the normal course.

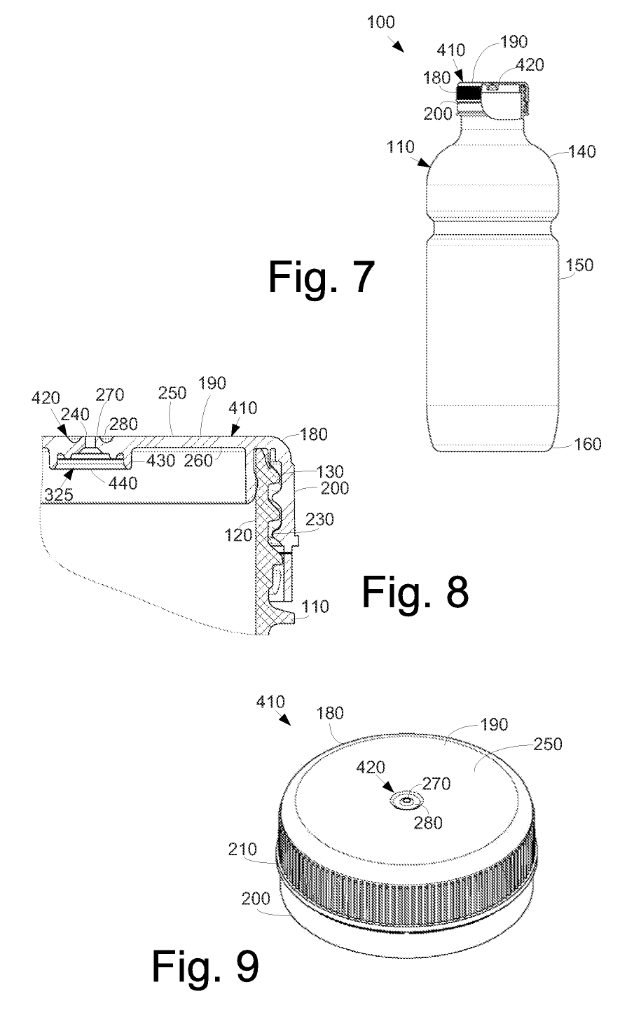

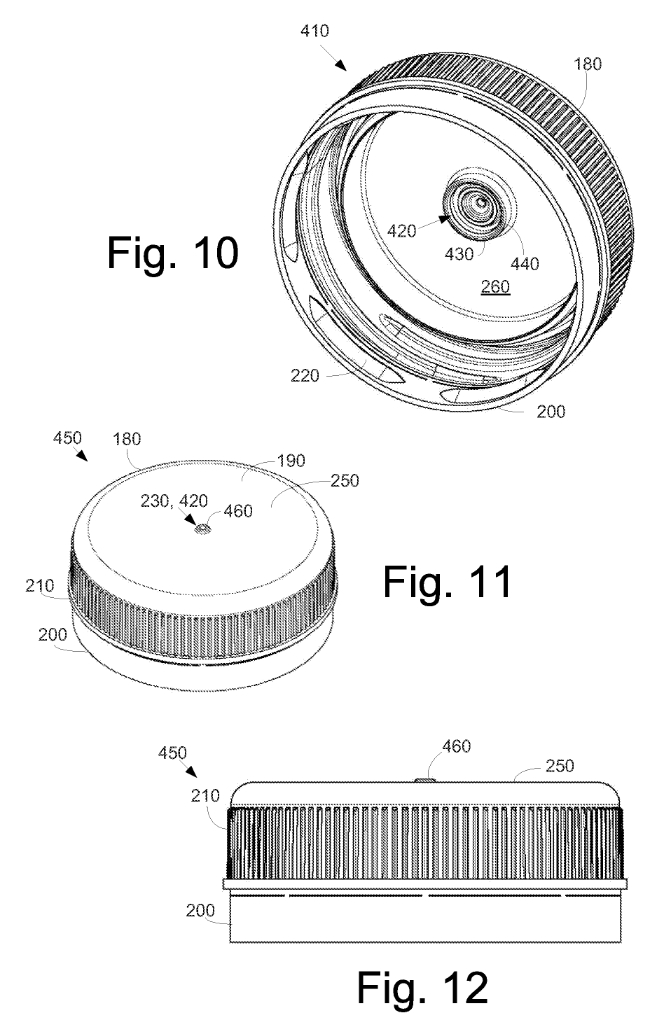

FIGS. 7-10 show an alternative embodiment of a closure 410 as may be described herein and as may be used on the bottle 110 as part of the container 100 and the like. The closure 410 also includes a vent 420 positioned about the middle of the flat surface 190 with the vent hole 240 extending therethrough. The vent 420 also includes the recessed dimple 270 on the top side 250 with the surrounding ring 280 in a manner similar to the closure 170 described above.

The vent 420 also includes a retaining ring 430 on the bottom side 260. In this example, the retaining ring 430 may not be as deep as the retaining ring 290 as described above. A porous component 325 may be heat sealed to the bottom of the retaining ring 430, in this example, the porous component 325 may be a porous sheet 440. The porous sheet 440 may be made out of a PET or polypropylene material and the like. The porous sheet 440 may have a pore size of about 0.2 to about 1.0 microns or larger. The porous sheet may be made out of a hydrophobic or a hydrophilic material. The use of the porous sheet 440 with the smaller pore size increasingly limits the flow of contaminates therethrough but may require a longer venting period as compared to the porous plug 330 and the like. Other components and other configurations may be used herein.

FIGS. 11 and 12 show an alternative embodiment of a closure 450 as may be described herein. The closure 450 may be similar to the closures 170, 410 described above, but uses a raised dimple 460 instead of the recessed dimple 270 within the ring 280 as is described above. Rather, the raised dimple 460 extends slightly above the top side 250 of the flat surface 190. The vent hole 240 thus may extend through the raised dimple 460 from the top side 250 to the bottom side 260 of the flat surface 190. The raised dimple 460 may include an additional amount of excess material for use in the laser sealing process. The raised dimple 450 may be used with either vent 230, 420. Other components and other configurations also may be used herein.

The use of the closures 170, 410, 450 with the container 100 thus allows the container 100 to vent when used in hot fill processes. As a result, the bottle 110 need not be as complex or use as much of a polymer material as is typical in hot fill processes. For example, a typical 32 ounce (0.95 liters) bottle used for a sports drink can have about 44 grams of material so as to accommodate the hot fill processes. Using the closures 170, 410, 450 described herein, only about 30 grams of material may be required. As such, the bottles 110 may be considerably less expensive to make and also may require considerably less polymer material. Less material to make the containers 100 also means less material to be disposed of and/or recycled after use of the containers 100. Moreover, the use of the laser sealing of the vent hole 240 helps to ensure that the hot fill bottling line 340 described herein can maintain the existing typical filling-line speeds of about 600 to about 800 containers 100 per minute. Other speeds and configurations may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A container for a beverage filled in a hot fill process, comprising:
a bottle; and
a closure;
the closure comprising a vent therein;
the vent comprising a top side with an amount of excess material and a bottom side with a porous component.

2. The container of claim 1, wherein the vent comprises a ring surrounding the amount of excess material.

3. The container of claim 2, wherein the amount of excess material comprises a recessed dimple.

4. The container of claim 1, wherein the amount of excess material comprises a raised dimple.

5. The container of claim 1, wherein the vent comprises a vent hole extending through the amount of excess material.

6. The container of claim 1, wherein the vent comprises a retaining ring in communication with the porous component.

7. The container of claim 1, wherein the porous component comprises a porous plug.

8. The container of claim 7, wherein the porous plug comprises a pore size of about 8 to about 15 microns.

9. The container of claim 1, wherein the porous component comprises a porous sheet.

10. The container of claim 9, wherein the porous sheet comprises a pore size of about 0.2 to about 1.0 microns.

11. The container of claim 1, wherein the bottle comprises a first number representing grams of a polymer material therein and a second number representing milliliters of a beverage therein and wherein the first number is less than or equal to the second number.

12. The container of claim 1, wherein closure comprises a dark material.

13. A method of bottling a hot liquid, comprising:
filling a bottle with the hot liquid;
capping the bottle with a vented closure;
cooling the hot liquid within the bottle;
pulling air into the bottle through the vented closure; and
sealing the vented closure.

14. The method of claim 13, wherein the sealing step comprises laser sealing the vented closure.

15. The method of claim 13, further comprising the step of laser welding, heat sealing, or ultrasonically sealing a porous component in the vented closure.

16. A hot fill bottling line, comprising:
a filling station for filling a bottle with a hot liquid;
a capping station for capping the bottle with a vented closure;
a cooling station for cooling the hot liquid and pulling air through the vented closure; and
a sealing station for sealing the vented closure.

17. The hot fill bottling line of claim 16, wherein the sealing station comprises one or more lasers therein.

18. The hot fill bottling line of claim 17, wherein the one or more lasers comprise about 10 to about 50 watts of sealing energy.

19. The hot fill bottling line of claim 16, wherein the sealing station comprises a pyrometer.

20. The hot fill bottling line of claim 16, further comprising a speed of about 600 to about 800 bottles per minute.
